(19) United States
(12) Patent Application Publication
(10) Pub. No.: US 2016/0346880 A1
(43) Pub. Date: Dec. 1, 2016

(54) METHOD FOR ASSEMBLING A MOTOR VEHICLE MODULE

(71) Applicant: THYSSENKRUPP PRESTA TECCENTER AG, Eschen (LI)

(72) Inventor: Heiko SCHMID, Nendeln (LI)

(73) Assignee: ThyssenKrupp Presta TecCenter AG, Eschen (LI)

(21) Appl. No.: 15/114,618

(22) PCT Filed: Jan. 23, 2015
(86) PCT No.: PCT/EP2015/000126

§ 371 Date: Jul. 27, 2016

(30) Foreign Application Priority Data
Jan. 29, 2014 (DE) 10 2014 101 088.4

(51) Int. Cl. B23P 11/02; F01L 1/047

(52) U.S. Cl. CPC B23P 11/025; F01L 1/047; B23P 2700/02; F01L 2001/0471; F01L 2001/0476

(57) ABSTRACT

Methods for assembling motor vehicle modules that include a shaft, a functional element, and a housing part are disclosed. The shaft may be arranged rotatably in bearing receptacles of the housing part, and the functional element may be fastened by a hub opening on a thickened portion of the shaft. The functional element may first be inserted into the housing part, wherein the shaft can then be pushed in by way of a temperature difference. During the pushing-in of the shaft, the functional element may not yet be in its final axial position and may not yet have its final orientation with respect to the angle of rotation, wherein the positionally correct positioning of the functional element may subsequently take place by way of press compaction. Before the shaft is inserted into the housing part, at least one of the bearing receptacles may be formed in such a manner that a rolling bearing is inserted, in particular pressed, in a receiving opening of the housing part.

The present invention relates to a method for assembling a motor vehicle module which has a shaft provided with at least one functional element, and a housing part, wherein the shaft is arranged rotatably in bearing receptacles of the housing part, and wherein the at least one functional element is fastened by a hub opening on a thickened portion of the shaft. The method here comprises the following steps:
arranging the at least one functional element within the housing part in such a manner that the hub opening is aligned with the bearing receptacles;
producing a temperature difference between the housing part and the shaft, at which the shaft is inserted into the housing and is guided here by the thickened portion through at least one of the bearing receptacles;
bringing about a temperature equalization between shaft and housing part;
positionally correctly arranging the at least one functional element in relation to the shaft; and producing an interference fit between hub opening and the associated thickened portion.

In particular, the motor vehicle module can be a cam shaft arrangement in which the cam shaft is mounted directly on a cylinder head or in a cylinder head cover.

A method of the type in question is known from DE 10 2010 045 047 A1, wherein, after the arranging of the at least one functional element within the housing part, the producing of a temperature difference and the insertion of the shaft, first of all temperature equalization between shaft and housing part is brought about before the at least one functional element is arranged in a positionally correct manner in relation to the shaft, and wherein the at least one functional element is subsequently arranged in a positionally correct manner in relation to the shaft by press compaction of the hub opening with the associated thickened portion.

In order to reduce the outlay on installation during the assembly of a motor vehicle engine and to reduce the storage and logistical costs of the installation of the engine, modules which are already premanufacted can be supplied to car manufacturers. Such a motor vehicle engine module can consist, for example, of at least one cam shaft and a housing in the form of a cylinder head or a cylinder head cover, wherein the cam shaft is already mounted rotatably in the corresponding housing part.

DE 10 2010 045 047 A1 describes a method in which functional elements in the form of cams are joined to a shaft within the cylinder head cover, and therefore the bearing receptacles can be formed integrally. A unit is therefore formed in which the cam shaft with the cams can no longer be separated from the cylinder head cover or alternatively the cylinder head without being destroyed.

The cams are arranged with hub openings in alignment with the bearing receptacles of the cylinder head cover, wherein only the sequence of the components with respect to one another and with respect to the bearing receptacles is taken into consideration, and wherein the components are not yet held in their final angular position. A temperature difference is then produced which makes it possible for the shaft to be pushed into the passage openings and into the bearing receptacles, wherein the functional elements in the form of cams are then in each case arranged adjacent to a thickened portion of the shaft in the form of a diameter extension.

Alternatively, a slight overlapping of the functional elements with an edge of the thickened portion can be provided in order to prefix the functional elements initially in an unordered or not yet functionally satisfactory angular arrangement.

After temperature equalization, the hub openings no longer fit over the diameter extensions, which are formed, for example, by roller-burnished portions, and therefore said functional elements are then pressed onto the associated diameter extension, wherein first of all the components are aligned with respect to one another in a predetermined angular position and are arranged axially in their final position on the shaft. If the functional elements are prefixed, as described previously, said functional elements are detached beforehand from the diameter extension and are only then oriented and pressed on.

The known method of the type in question is distinguished in that the individual cams or functional elements do not yet have to be precisely oriented during the pushing-in of the shaft. It is therefore not necessary to fix the parts with a large outlay in a holding frame or the like. On the contrary, the individual functional elements can be pressed one after another onto the shaft, wherein the shaft should then be rotated in a suitable manner merely from pressing-on operation to pressing-on operation in order to reach a positionally correct angular orientation of all of the functional elements.

A method in which the functional elements to be mounted have to be held in a frame is known from EP 1 155 770 B1.

The method described at the beginning has proven successful for producing cam shaft modules. However, there is the need to improve the load-bearing capacity and wear resistance of the motor vehicle module.

The object is achieved by, and the invention relates to, a method as claimed in claim 1. Starting from a method with the features described at the beginning, it is provided according to the invention that, before the shaft is inserted into the housing part, at least one of the bearing receptacles is formed in such a manner that a rolling bearing is inserted, in particular pressed, in a receiving opening of the housing part.

According to the invention, an additional method step prior to the installation of the shaft is therefore provided, in which a rolling bearing is inserted on at least one bearing receptacle. As a result, the leadthrough in the corresponding bearing receptacle is therefore formed by the inside diameter of the rolling bearing, i.e. customarily by the inner ring of the rolling bearing.

This results in a plurality of advantages in relation to the known method. First of all, a small amount of friction can be permanently achieved between the housing part and the shaft mounted rotatably thereon.

In addition, there is also a simplification because at least the bearing receptacle provided with the rolling bearing does not need any complicated surface machining of the shaft in order to permit a precise sliding mounting.

Furthermore, in the known method for producing a defined bearing gap for the sliding mounting, the bearing receptacle is precisely co-ordinated with the correspondingly associated outside diameter of the shaft. If, instead, a rolling bearing is used, according to a preferred embodiment of the invention a press fit can be produced between the inner ring of the rolling bearing and the associated lateral surface of the shaft such that the shaft there therefore has an excess size in relation to the inner ring. If axial forces do not also have to be absorbed at the bearing, the force of the press fit may also vary to a certain extent, and therefore then all in all it is not necessary for exacting requirements to be imposed on the accuracy.

A further advantage can be seen in the fact that even relatively large tilting moments can be absorbed by a rolling bearing. Such tilting moments may occur in particular in the region of a drive of the shaft. For example, cam shafts are customarily driven by a toothed belt or a gear wheel, for which purpose a corresponding driving gear wheel is provided at one end of the cam shaft. By means of the tensioning of the toothed belt or of the control chain, tension is exerted on the cam shaft, said tension having to be absorbed as a tilting moment by the bearing receptacles.

Against this background, it can be provided that the shaft is arranged rotatably on one bearing receptacle by means of the rolling bearing and on another bearing receptacle by means of a sliding mounting, wherein the bearing point with the rolling bearing is formed on a side of the shaft that is provided with a shaft drive.

Such an embodiment is suitable in particular if high loadings are anticipated at one shaft end, but otherwise a sliding mounting is sufficient.

According to an alternative, preferred embodiment of the invention, all of the bearing receptacles of the housing part are each provided with a rolling bearing, as a result of which a particularly smooth-running and reliable mounting is permanently achieved.

In principle, different types of rolling bearings are suitable. Use is particularly preferably made of a needle bearing which, with a compact construction, is distinguished by a high supporting force in respect of loadings in the radial direction.

The method according to the invention is generally suitable for the assembly of a motor vehicle module, in particular a motor vehicle engine module, which has a shaft with functional elements that is arranged in a housing part. This is preferably a cam shaft module, but, for example, it is also possible for an eccentric shaft module to be mounted with the method according to the invention.

According to a preferred embodiment of the invention, it is provided, starting from the method known from DE 10 2010 045 047 A1, that, in the method for assembling the motor vehicle module, the steps stated below are carried out in the stated sequence:
arranging the at least one functional element within the housing part in such a manner that the hub opening is aligned with the bearing receptacles;
producing a temperature difference between the housing part and the shaft, at which the shaft is inserted into the housing and is guided here by the thickened portion through at least one of the bearing receptacles;
bringing about a temperature equalization between shaft and housing part before the at least one functional element is arranged in a positionally correct manner in relation to the shaft; and
positionally correctly arranging the at least one functional element in relation to the shaft by press compaction of the hub opening with the associated thickened portion.

However, within the scope of the invention, a different method procedure is also possible. For example, the positionally correct arrangement of the at least one functional element can basically also take place before the temperature equalization between shaft and housing part is brought about, and then an interference fit between the hub opening of the associated thickened portion of the shaft is produced solely by the temperature equalization.

According to the invention, there is at least one functional element, but customarily a multiplicity of functional elements are mounted on the shaft, as described previously. In the case of a cam shaft module, all of the cams as functional elements are correspondingly first of all threaded in the described manner onto the shaft and are then arranged in a positionally correct manner by press compaction. In the case of a cam shaft module, a multiplicity of cams as functional elements are therefore connected to a respective thickened portion of the shaft, wherein, for the insertion of the shaft into the housing part, a temperature difference is also produced between the shaft and at least some of the cams, customarily all of the cams, and the shaft is guided by its thickened portions through the associated hub openings of said functional elements.

The temperature difference can be produced in different ways. Provision is preferably made for the shaft to be cooled and/or the housing part and the functional elements to be heated. Taking into consideration the co-efficient of expansion of metal, the shaft shrinks by cooling, while the housing part and the functional elements expand during heating. The expansion leads here to the diameter of the hub openings being extended.

Between the production of the temperature difference and the bringing about of the temperature equalization the shaft is preferably positioned in a positionally correct manner in the housing part in such a manner that the bearing receptacles overlap with bearing portions of the shaft. Provision can be made here in particular that, on at least one of the bearing receptacles, the bearing portion is connected in a press fit to an inner ring of the rolling bearing, i.e. a transverse press fit, when the temperature equalization is brought about. The shaft is then already accommodated and held in an axially fixed manner in the housing part, wherein the individual functional elements are then press-compacted preferably with a longitudinal press fit being produced.

By means of the fastening of the shaft to the rolling bearing in a first step and the subsequent fastening of the functional elements to the shaft, a particularly simple method procedure can be achieved, wherein different types of interference fits, namely a transverse press fit between shaft and in the ring of the rolling bearing, on the one hand, and a longitudinal press fit between shaft and functional element, on the other hand, can be combined in a particularly advantageous manner. The transverse press fit produced on the bearing receptacle between inner ring and shaft in the first method step is sufficient in order to fix the shaft axially to a certain extent and copes with the loadings occurring at the bearing receptacle. With the longitudinal press fit, in particular in combination with a contouring of the hub opening and/or of the thickened portion, a particularly reliable connection which is rotationally fixed even under elevated torques, can be ensured.

In order, within the scope of the described method, to accelerate the temperature equalization, the shaft and the housing part can be exposed to a fluid, for example compressed air or a liquid, such as water, in order to heat up the colder part or to cool down the warmer part.

The thickened portions can be formed by a simple deformation process of the shaft, for example the production of a roller-burnished portion.

According to the invention, the rolling bearing is arranged in the associated receiving opening before the shaft is inserted. However, starting therefrom, variation possibilities still remain in respect of the precise sequence of the individual method steps. The rolling bearing can thus be inserted into the associated receiving opening in a first method step taking place entirely beforehand.

Furthermore, the rolling bearing can also be inserted into the receiving opening when the functional elements are arranged in alignment with their hub openings within the housing part. However, in contrast to the functional elements, the rolling bearing is then already arranged in its final position in the axial direction with respect to the housing part.

Finally, it is basically also possible to insert the rolling bearing into an associated receiving opening just immediately before the shaft is introduced. If, for example, the housing part has a high temperature, the shaft has a low temperature and the rolling bearing has a medium temperature and the dimensions are co-ordinated with one another in a suitable manner, the rolling bearing can be inserted at its outer circumference into the associated receiving opening with play, wherein the shaft can simultaneously also be guided with play through the inner ring of the rolling bearing. An interference fit between the outer ring and the receiving opening, on the one hand, and between the inner ring and the shaft, on the other hand, then takes place only when the temperature of the parts is equalized.

The invention is explained below with reference to a figure which merely illustrates an exemplary embodiment. In the figure:

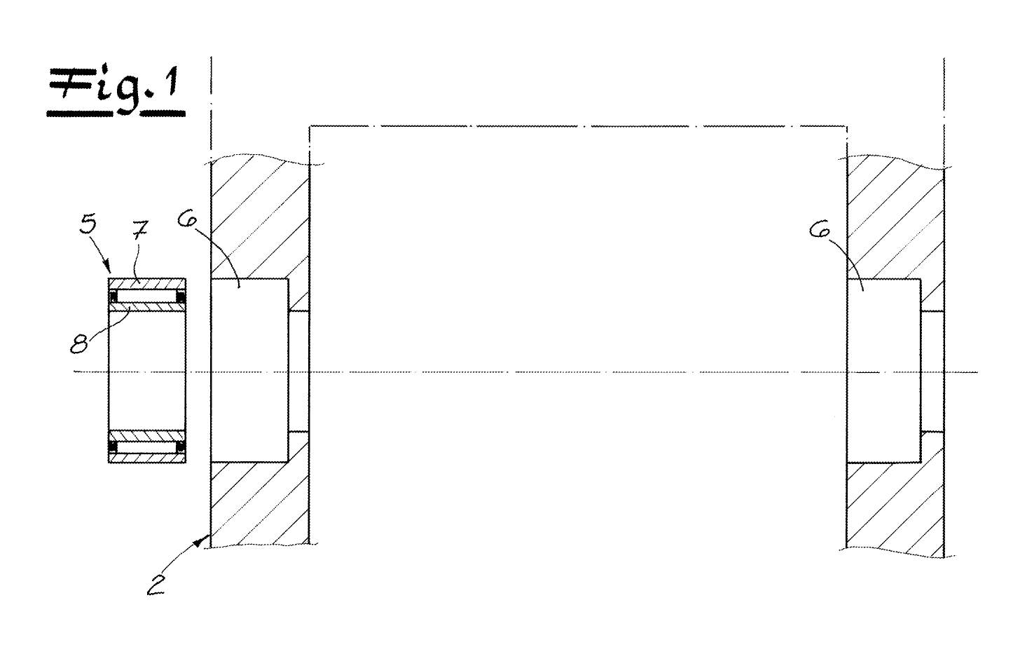

FIG. 1 shows a first method step for assembling a motor vehicle module, wherein, in order to form a bearing receptacle, a rolling bearing is inserted into a receiving opening,

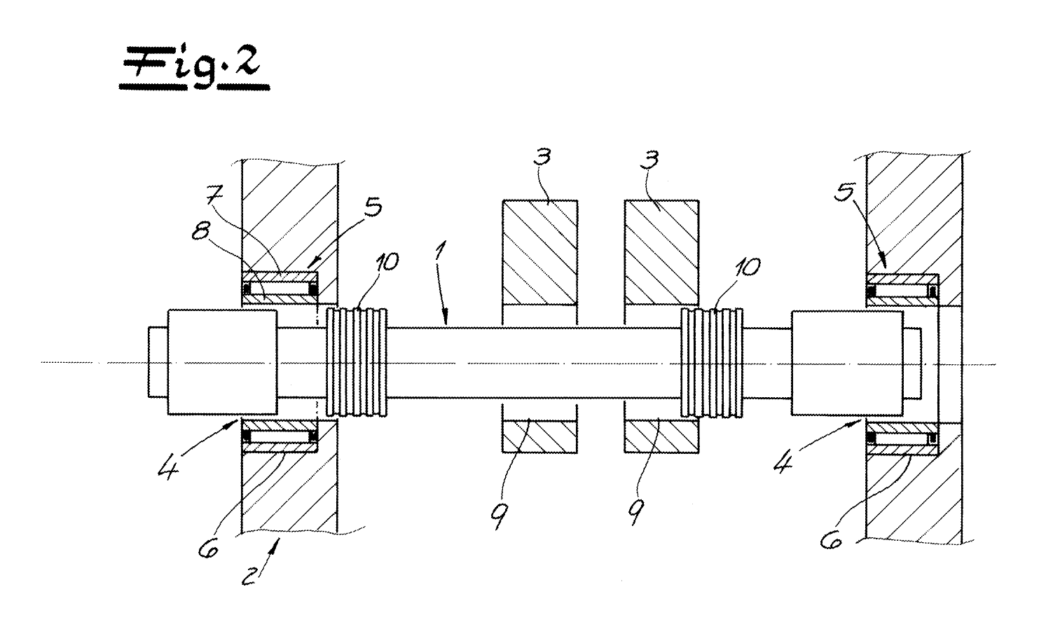

FIG. 2 shows the insertion of a shaft into the housing part illustrated in FIG. 1,

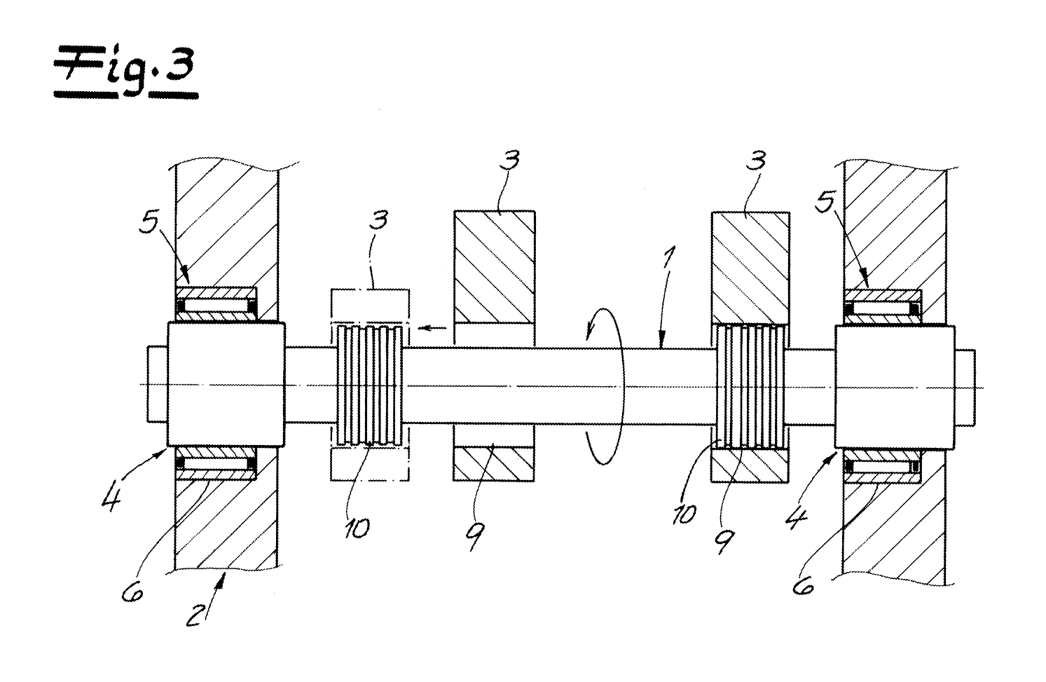

FIG. 3 shows a method step for positioning functional elements on the shaft,

FIG. 4 shows a motor vehicle module in longitudinal section,

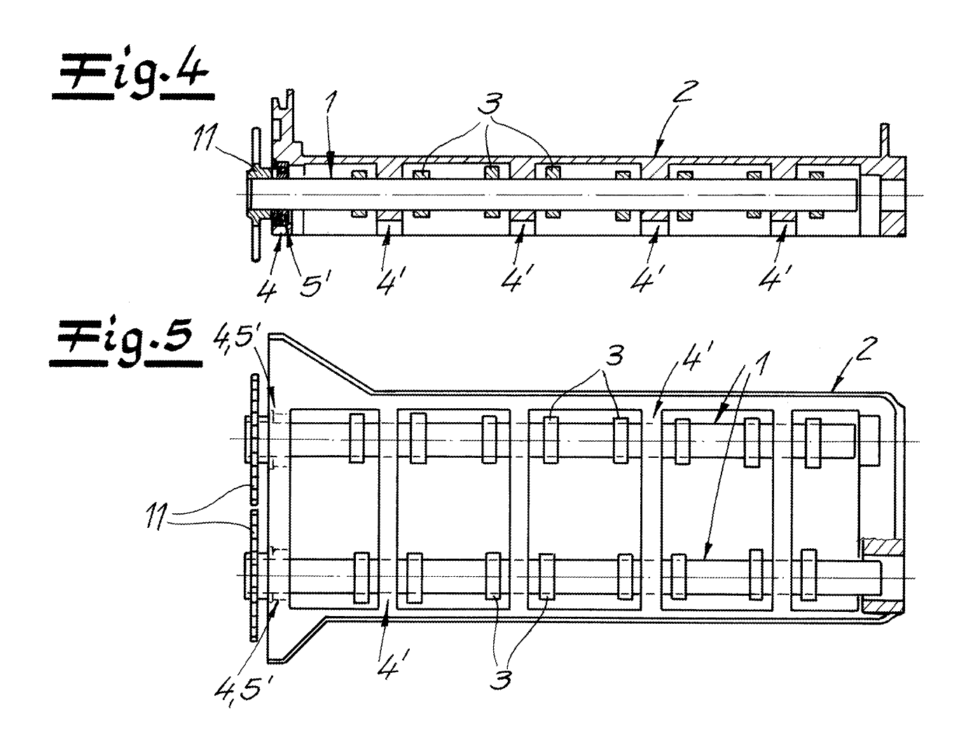

FIG. 5 shows the motor vehicle module according to FIG. 4 in a view from below.

The present invention relates to a method for assembling a motor vehicle module, in particular a motor vehicle engine module, which has a shaft 1 provided at least with one functional element, and a housing part 2. In particular, the module is a cam shaft arrangement, wherein the shaft 1 is inserted with functional elements in the form of cams 3 into the housing part 2. The housing part 2 is then either a cylinder head or a cylinder head cover in which the cam shaft is installed.

In this connection, FIG. 1 shows a first method step in order to form bearing receptacles 4, which each have a rolling bearing 5, on the housing part 2. The rolling bearing 5, a needle bearing in the exemplary embodiment illustrated, is inserted into an associated receiving opening 6 of the housing part 2. In particular, the rolling bearing 5 can be pressed into the receiving opening 6. The pressing-in can take place in the axial direction by an outer ring 7 of the rolling bearing 5 having a slight excess size in relation to the receiving opening 6. Alternatively, a shrink pressing can also take place by the housing part 2 being heated, at least in the region of the receiving opening 6, and therefore being expanded, and/or by the rolling bearing 5 being cooled and therefore shrunk.

If the rolling bearing 5 is inserted into the receiving opening 6, an inner ring 8 forms the clear opening in the bearing receptacle 4.

In the following, cams 3 are arranged in a manner known per se on the housing part 2 such that hub openings 9 of the cams 3 are aligned with the inner rings 8 as lead throughs of the bearing receptacles 4, whereupon the shaft is then pushed in (FIG. 2).

At the axial positions at which the cams 3 are to be arranged, the shaft 1 has a respective roller-burnished portion 10. The shaft 1 can be pushed through the bearing receptacles 4 and the hub openings 9 because a temperature difference is produced between the shaft 1, on the one hand, and the housing part 2 and the cams 3, on the other hand. In particular, the shaft 1 can be shrunk by cooling, wherein, additionally or alternatively, the bearing receptacles 4 and the cams 3, and therefore also the hub openings 9, are expanded by heating.

According to FIG. 2, the individual cams 3 are not yet in their end position with respect to their axial orientation and their angular orientation. The cams 3 are arranged next to the roller-burnished portions 10. Alternatively, it can be provided that the cams 3 are arranged at the edge of the roller-burnished portion 10 and first of all have to be detached again.

In order to bring the cams 3 into their final position, said cams are pressed onto the roller-burnished portion 10. At the same time, the cams 3 are also arranged in the correct angular relationship with respect to one another. According to FIG. 3, this is possible in a particular simple manner by the fact that the cams 3 are pressed individually onto the respective roller-burnished portion 10, wherein the shaft 1 is rotated to a suitable extent between the consecutive pressing-on operations for the individual cams 3.

According to the exemplary embodiment of FIG. 3, rolling bearings 5 are provided on the two bearing receptacles 4 illustrated. In a corresponding manner, a plurality of bearing receptacles 4 which each have a rolling bearing 5 can be present along the entire shaft 1.

Starting therefrom, FIG. 4 shows an alternative embodiment in which a rolling bearing 5′ is present only on one bearing receptacle 4, while a sliding mount takes place on the remaining bearing receptacles 4′. The rolling bearing 5′ a ball bearing in the exemplary embodiment illustrated, is provided in order to be able to absorb increased forces at the corresponding end of the shaft 1, which forces are exerted by a driving gearwheel 11 mounted on the shaft 1. According to FIG. 4, the shaft 1 with the cams 3 arranged thereon is arranged in a housing part 2 in the form of a cylinder head cover.

FIG. 5 shows the cylinder head cover in a view from below, wherein two shafts 1 with cams 3 for controlling the inlet valves and the outlet valves of an internal combustion engine are arranged there. Starting from the respective driving gearwheel 11 in the first bearing receptacle 4, the support for the two shafts 1 is provided by a rolling bearing 5′.

1.-10. (canceled)

11. A method for assembling a motor vehicle module including a shaft, a functional element, and a housing part, wherein the shaft is rotatably disposed within bearing receptacles of the housing part, wherein the functional element is fastened by a hub opening on a thickened portion of the shaft, the method comprising:
positioning the functional element within the housing part so that the hub opening of the functional element is aligned with the bearing receptacles;
forming at least one of the bearing receptacles by inserting a rolling bearing into a receiving opening of the housing part;
generating a temperature difference between the housing part and the shaft before inserting the shaft into the housing part, wherein the shaft is guided into the housing part by the thickened portion through at least one of the bearing receptacles;
causing or permitting a temperature equalization between the shaft and the housing part;
positioning the functional element in a correct position relative to the shaft; and
producing an interference fit between the hub opening and the thickened portion.

12. The method of claim 11 wherein the temperature equalization between the shaft and the housing part occurs before the functional element is positioned in the correct position relative to the shaft, wherein the functional element is positioned in the correct position relative to the shaft by press compaction of the hub opening with the thickened portion.

13. The method of claim 11 wherein the rolling bearing inserted into the receiving opening of the housing part is a needle bearing that is pressed into the receiving opening of the housing part.

14. The method of claim 11 wherein all of the bearing receptacles of the housing part comprise a rolling bearing.

15. The method of claim 11 wherein the shaft is rotatably positioned on one of the bearing receptacles by way of the rolling bearing and on another of the bearing receptacles by way of a sliding mounting, wherein the bearing receptacle with the rolling bearing is formed on a side of the shaft that includes a shaft drive.

16. The method of claim 11 wherein a plurality of cams as functional elements are connected to thickened portions of the shaft, wherein for the insertion of the shaft into the housing part a temperature difference is produced between the shaft and at least some of the cams, wherein the shaft is guided by the thickened portions through hub openings of the functional elements.

17. The method of claim 11 wherein between generating the temperature difference and causing or permitting the temperature equalization, the method further comprises positioning the shaft in a correct position in the housing part such that the bearing receptacles overlap with bearing portions of the shaft.

18. The method of claim 17 wherein on at least one of the bearing receptacles the bearing portion is connected to an inner ring of the rolling bearing in a press fit relationship when the temperature equalization occurs.

19. The method of claim 11 wherein the generating the temperature difference between the housing part and the shaft comprises at least one of cooling the shaft or heating the functional element.

20. The method of claim 11 further comprising forming the thickened portion of the shaft by roller burnishing.
